(19) United States
(12) Patent Application Publication
(10) Pub. No.: US 2021/0027298 A1
(43) Pub. Date: Jan. 28, 2021

(54) METHOD AND APPARATUS FOR AUTHENTICATING ADDRESS OF VIRTUAL ASSET

(71) Applicant: Dunamu Inc., Seoul (KR)

(72) Inventor: Minseok JUNG, Yongin-si (KR)

(21) Appl. No.: 16/931,629

(22) Filed: Jul. 17, 2020

(30) Foreign Application Priority Data
Jul. 17, 2019 (KR) 0-2019-0086454
Jul. 17, 2020 (KR) 10-2020-0088802

(51) Int. Cl. G06Q 20/40; G06Q 20/36; G06Q 20/38; H04L 9/06

(52) U.S. Cl. CPC G06Q 20/4014; G06Q 20/3674; H04L 2209/56; H04L 9/06; H04L 2209/38; G06Q 20/388

(57) ABSTRACT

A method and an apparatus for authenticating an address of virtual assets through steps of: requesting a Know Your Customer (KYC) server to perform a KYC of user based on user information of the user; transmitting amount information of the virtual assets to terminal of the user when the KYC is successful by the KYC server; and authenticating the address by confirming that an amount of the virtual assets corresponding to the amount information has been withdrawn from the address are provided.

### CROSS-REFERENCE TO RELATED APPLICATION

This application claims priority to and the benefit of Korean Patent Application No. 10-2019-0086454 filed in the Korean Intellectual Property Office on Jul. 17, 2019, and Korean Patent Application No. 10-2020-0088802 filed in the Korean Intellectual Property Office on Jul. 17, 2020, the entire contents of which are incorporated herein by reference.

### BACKGROUND OF THE INVENTION

### (a) Field of the Invention

This disclosure relates to a method and an apparatus for authenticating an address of virtual assets.

### (b) Description of the Related Art

Cryptoasset is a compound word of ‘crypto-’ meaning ‘encryption’ and ‘asset’ meaning ‘property’. The cryptoasset belongs to digital assets that can be securely exchanged through public key encryption on a distributed ledger, and ownership of the cryptoasset may be proved relatively easily using a hash function. In general, cryptoasset may operate on the distributed ledger based on blockchain or DAG (Directed Acyclic Graph). The cryptoasset is also referred to as virtual assets.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present disclosure has been made in an effort to provide a method, an apparatus, and a server for authenticating an address of virtual assets.

An exemplary embodiment provides a method for authenticating an address of virtual assets.

Another exemplary embodiment provides an apparatus for authenticating an address of virtual assets.

Yet another exemplary embodiment provides a server for requesting an authentication of an address of virtual assets.

According to the exemplary embodiment, the method for authenticating an address of virtual assets includes: requesting a Know Your Customer (KYC) server to perform a KYC of user based on user information of the user; transmitting amount information of the virtual assets to terminal of the user when the KYC is successful by the KYC server; and authenticating the address by confirming that an amount of the virtual assets corresponding to the amount information has been withdrawn from the address.

The authenticating the address by confirming that an amount of the virtual assets corresponding to the amount information has been withdrawn from the address may include confirming that the amount of the virtual assets corresponding to the amount information has been transferred from the address to an address being different from the address.

The authenticating the address by confirming that an amount of the virtual assets corresponding to the amount information has been withdrawn from the address may include confirming that the amount of the virtual assets corresponding to the amount information has been transferred from the address to an address which is owned or possessed by the user and is different from the address.

The authenticating the address by confirming that an amount of the virtual assets corresponding to the amount information has been withdrawn from the address may include confirming that the amount of the virtual assets corresponding to the amount information has been transferred from the address to the same address as the address.

The transmitting amount information of the virtual assets to terminal of the user may include transmitting information about the amount of the virtual assets and a specific address to the terminal, and the authenticating the address by confirming that an amount of the virtual assets corresponding to the amount information has been withdrawn from the address may include confirming that the amount of the virtual assets corresponding to the amount information has been transferred from the address to the specific address.

The transmitting amount information of the virtual assets to terminal of the user may include transmitting the amount information of the virtual assets and specific information to the terminal, and the authenticating the address by confirming that an amount of the virtual assets corresponding to the amount information has been withdrawn from the address may include confirming that the amount of the virtual assets corresponding to the amount information has been withdrawn from the address; checking whether contents corresponding to the specific information is included in a metadata field or a tag field of a transaction corresponding to the withdrawal; and determining that the address is authenticated when it is confirmed that the amount of the virtual assets corresponding to the amount information has been withdrawn from the address and it is confirmed that the contents corresponding to the specific information has been included in the metadata field or the tag field of the transaction corresponding to the withdrawal.

The requesting a Know Your Customer (KYC) server to perform a KYC of user based on user information of the user may include requesting a KYC server of a country corresponding to nationality information of the user received from the terminal to perform the KYC.

The requesting a Know Your Customer (KYC) server to perform a KYC of user based on user information of the user may include requesting a KYC server of a country in which an address authentication server is located to perform the KYC, wherein the address authentication performs the method for authenticating of the address of the virtual assets.

The requesting a Know Your Customer (KYC) server to perform a KYC of user based on user information of the user may include generating a user key based on the user information, and requesting, by using the user key, the KYC server to perform the KYC.

The requesting a Know Your Customer (KYC) server to perform a KYC of user based on user information of the user may include encrypting the user information and delivering the encrypted user information to the KYC server.

After the transmitting amount information of the virtual assets to terminal of the user when the KYC is successful by the KYC server, the method may further include: operating a timer and monitoring that an amount of the virtual assets corresponding to the amount information is withdrawn from the address.

The authenticating the address by confirming that an amount of the virtual assets corresponding to the amount information has been withdrawn from the address may include determining that the address is authenticated when the amount of the virtual assets is withdrawn from the address before the timer expires.

The authenticating the address by confirming that an amount of the virtual assets corresponding to the amount information has been withdrawn from the address may include confirming that a block containing a transaction corresponding to the withdrawal of the amount of the virtual assets from the address is added to a blockchain.

The authenticating the address by confirming that an amount of the virtual assets corresponding to the amount information has been withdrawn from the address may include confirming that a block containing a transaction corresponding to the withdrawal of the amount of the virtual assets from the address is agreed to be legitimate.

The method may further include matching and managing the address and a user key generated based on the user information.

The address may be a virtual assets address created offline by the user.

The address may be a virtual assets address created by a virtual assets transaction program.

The address may be a virtual assets address created by an exchange of the virtual assets.

According to another exemplary embodiment, the apparatus for authenticating an address of virtual assets includes: a processor, a memory, and a communication device, wherein the processor executes a program stored in the memory to perform: requesting a Know Your Customer (KYC) server to perform a KYC of user through the communication device based on user information of the user; instructing a terminal of the user through the communication device to withdraw a specific amount of the virtual assets from the address when the KYC is successful by the KYC server; and determining that the address is authenticated when it is confirmed that the specific amount of the virtual assets are withdrawn from the address.

According to the yet another exemplary embodiment, the server for requesting an authentication of an address of virtual assets includes: a processor, a memory, and a communication device, wherein the processor executes a program stored in the memory to perform: receiving, from an address authentication server, an instruction to withdraw a specific amount of the virtual assets from the address of the virtual assets of user when a Know Your Customer (KYC) of the user is successful by a KYC server based on user information of the user; transferring the instruction to a terminal of the user; and receiving a success message for the authentication of the address generated by the address authentication server from the address authentication server and transmitting the success message to the terminal when the specific amount of the virtual assets is withdrawn from the address of the virtual assets.

### BRIEF DESCRIPTION OF THE DRAWINGS

FIG. 1 is a schematic diagram illustrating a method for processing a withdrawal request of virtual assets by an exchange according to an exemplary embodiment.

FIG. 2 is a schematic diagram illustrating a network between Exchanges according to an exemplary embodiment.

FIG. 3 is a flowchart illustrating a method of providing an address authentication service for authenticating the address for virtual assets according to an exemplary embodiment.

FIG. 4 is a schematic diagram illustrating a virtual assets address authentication server and KYC servers of each country of a virtual assets network according to an exemplary embodiment.

FIG. 5 is a flowchart illustrating a method of providing an address authentication service for authenticating the address of virtual assets according to another exemplary embodiment.

FIG. 6 is a block diagram illustrating an address authentication apparatus and a terminal for virtual assets according to an exemplary embodiment.

### DETAILED DESCRIPTION OF THE EMBODIMENTS

In the following detailed description, only certain exemplary embodiments of the present invention have been shown and described in detail with reference to the accompanying drawing, simply by way of illustration. However, the present disclosure may be implemented in various different forms and is not limited to the exemplary embodiments described herein. Further, in order to clearly describe the description in the drawing, parts not related to the description are omitted, and similar reference numerals are attached to similar parts throughout the specification.

In this specification, unless explicitly described to the contrary, the word “comprise”, and variations such as “including” or “containing”, will be understood to imply the inclusion of stated elements but not the exclusion of any other elements.

In this specification, expressions described in singular can be interpreted as singular or plural unless explicit expressions such as “one” or “single” are used.

In this specification, “and/or” includes all combinations of each and at least one of the mentioned elements.

In this specification, terms including ordinal numbers such as first and second may be used to describe various configurations elements, but the elements are not limited by the terms. The terms may be only used to distinguish one element from another element. For example, a first element may be named a second element without departing from the right range of the present disclosure, and similarly, a second element may be named a first element.

In the flowchart described with reference to the drawings in this specification, the order of the operations may be changed, several operations may be merged, certain operations may be divided, and specific operations may not be performed.

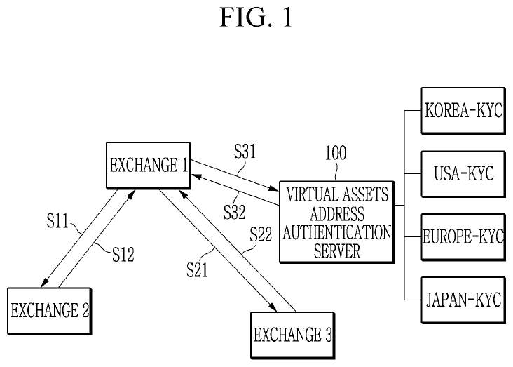

FIG. 1 is a schematic diagram illustrating a method for processing a withdrawal request of virtual assets by an exchange according to an exemplary embodiment.

Referring to FIG. 1, when a user withdraws virtual assets (or cryptocurrency, virtual currency, etc.) from an address of the user through Exchange 1, or when the user sends the virtual assets to an address of a counterparty, the Exchange 1 may confirm through another Exchange whether the user or the counterparty has been authenticated through a Know Your Customer (KYC) procedure. For example, the Exchange 1 may query Exchange 2 for a KYC history of the user or the counterparty (S11) and receive a response to the query from the Exchange 2 (S12). If the KYC history of the user or the counterparty exists in the Exchange 2, the Exchange 1 may allow the virtual assets to be transferred to a designated address.

The Exchange 1 may query another Exchange (e.g., Exchange 3) for the KYC history of the user or the counterparty (S21) and receive a response to the query (S22). The Exchange 1 may query the Exchange 2 for the KYC history and simultaneously query other Exchanges for the KYC history, or the Exchange 1 may query the other Exchange for the KYC history before receiving the response from Exchange 2.

When the KYC history of the user or the counterparty is not confirmed through other Exchanges, the Exchange 1 may query the KYC history of the user or the counterparty to a virtual assets address authentication server 100 (S31). When the user or the counterparty is an address of an individual (or natural person) or a corporation that has gone through the KYC procedure, the virtual assets address authentication server 100 may respond to the Exchange 1 that the KYC history of the user or the counterparty exists (S32). Then, the Exchange 1 may allow the virtual assets to be transferred to the address.

The Exchange 1 according to an exemplary embodiment may immediately check the KYC history of the user or the counterparty to the virtual assets address authentication server 100 without checking the KYC history with other Exchanges.

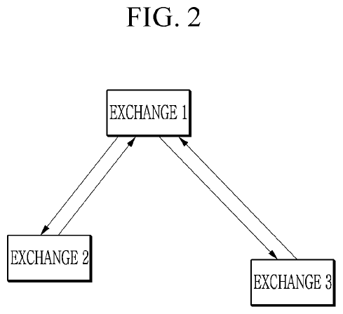

FIG. 2 is a schematic diagram illustrating a network between Exchanges according to an exemplary embodiment.

When the Exchange allocates an account address to a user, the Exchange may perform the KYC for the user. For example, the Exchange may employ, for the KYC, an identification service through a mobile phone, an identification card of an individual, or a selfie of the individual. In addition, the Exchange may conduct its own qualification screening for the KYC of a corporation. The exchange may also use a risk management data-based system, such as the World-Check, to prevent an account creation or assignment for the individual or the corporation which have anti-money laundering (AML) issues related to illegal activities such as fraud, bribery, organized crime, and terrorism. Afterwards, the Exchange may recover the previously assigned account if an AML problem occurs with an existing member through periodic screenings.

The exchange may check the KYC history of the owner (or holder or possessor) of the address from which the virtual assets will be withdrawn or the address to which the virtual assets will be transferred through other Exchanges to verify the address. If there is no KYC history of the owner (or holder or possessor) of the address from which the virtual assets is to be withdrawn or the address to which the virtual assets is to be transferred in the other Exchanges, the Exchange may query the virtual assets address authentication server which provides an address authentication service for the virtual assets for the KYC history of the owner (or holder or possessor) of the address. Alternatively, the Exchange may query the virtual assets address authentication server for the KYC history of the owner (or holder or possessor) of the address without querying other Exchanges for the KYC history.

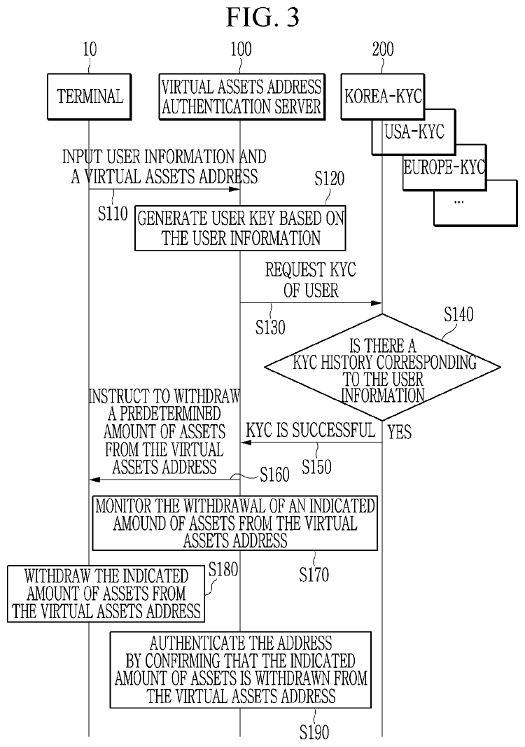

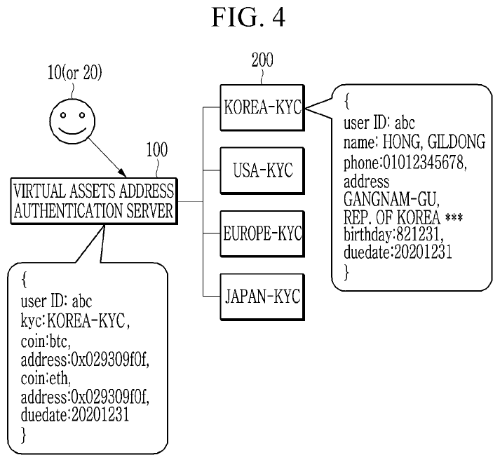

FIG. 3 is a flowchart illustrating a method of providing an address authentication service for authenticating the address for virtual assets according to an exemplary embodiment, and FIG. 4 is a schematic diagram illustrating a virtual assets address authentication server and KYC servers of each country of a virtual assets network according to an exemplary embodiment.

A virtual assets address authentication service may be provided to a user or an Exchange to prove to a counterparty and/or a third party that the address of the virtual assets of the user is owned or possessed by the user. For example, when the user directly creates the address of the virtual assets (e.g., created by a cold wallet or blockchain program, etc.), the virtual assets address authentication service may be provided to verity that the created address is owned or possessed by the user. In this case, the virtual assets address may be a virtual assets address created offline by the user or a virtual assets address created by a transaction program for the virtual assets. In addition, when the user trades the virtual assets through the Exchange 2 using the virtual assets address created in the Exchange 1, the user use the address authentication service to prove to the Exchange 2 that the virtual assets address created in the Exchange 1 is owned by the user.

Referring to FIG. 4, a user may input user information and the virtual assets address of the user to the virtual assets address authentication server 100 to authenticate his own virtual assets address (S110). In addition, the user may input a nationality of the user or information about the nationality to the virtual assets address authentication server 100. In addition, the user may input a type of the virtual assets to be stored in the virtual assets address to the virtual assets address authentication server 100. Alternatively, the type of the virtual assets to be stored in the virtual assets address may be known from a predetermined format of the virtual assets address by the virtual assets address authentication server 100. When the user subscribes to the virtual assets address authentication server 100 as a member, the user may input the user information, the virtual assets address, the nationality, and the type of the virtual assets to the virtual assets address authentication server 100.

The user may input the user information, the virtual assets address, the nationality, the virtual asset, etc. to the virtual assets address authentication server 100 through the terminal 10. Throughout the specification, the terminal 10 may indicate a user equipment (UE), a mobile station (MS), a mobile terminal (MT), an advanced mobile station (AMS), a high reliability mobile station (HR-MS), a subscriber station (SS), a portable subscriber station (PSS), an access terminal (AT), or a machine-type communication (MTC) device connected to the virtual assets address authentication server 100, and it may include entire or partial functions of the UE, MT, MS, AMS, HR-MS, SS, PSS, AT, and MTC device. Alternatively, the terminal 10 may refer to a personal computer (PC) or a server connected to the virtual assets address authentication server 100 by wired manner.

The virtual assets address authentication server 100 may generates a user key based on the user information (S120), and may request the KYC server to perform the KYC of the user by using the user key (S130). The user information may include a name, a portable phone number, an address, and/or a date of the birth or the user. The user key may be a means for specifying the user, and the virtual assets address authentication server 100 may employ other means for specifying the user in addition to the user key. The virtual assets address authentication server 100 may encrypt the user information and transmit the encrypted user information to the KYC server 200. For example, the virtual assets address authentication server 100 may deliver the user information to the KYC server 200 through a public key cryptography scheme such as an RSA or a DSA.

Here, the KYC server may be a server nationally certified such as a credit bureau (CB). In general, since the CB may receive personal information from financial institutions such as banks and credit card companies in order to evaluate individual credit rating, the server of the CB may be suitable for performing the KYC.

Upon receiving the request of the KYC for the user, the KYC server 200 may check whether a KYC history corresponding to the user information exists (S140). Each KYC server 200 may perform the KYC according to a predetermined method and level for the individuals and the corporations, and may match and store the user information and the KYC history. The KYC server 200 may update the user information and the KYC history according to a predetermined storage period.

The virtual assets address authentication server 100 may request a KYC server 200 of a country where the virtual assets address authentication server 100 is located to perform the KYC of the user. Alternatively, the virtual assets address authentication server 100 may request a KYC server 200 of a country corresponding to information about the nationality of the user input by the user to perform the KYC of the user. Alternatively, the virtual assets address authentication server 100 may simultaneously request a plurality of KYC servers 200 to perform the KYC of the user.

If the virtual assets address authentication server 100 receives a message that there is no KYC history from the first KYC server 200 to which the KYC request is transmitted or does not receive a response message from the first KYC server 200 within a predetermined time, the virtual assets address authentication server 100 may send the KYC request for the user to another KYC server.

After that, if the KYC fails by all KYC servers connected to the virtual assets address authentication server 100, the virtual assets address authentication server 100 may deliver an authentication failure message for the virtual assets address to the terminal 10. If the KYC fails, the virtual assets address authentication server 100 may match the virtual assets address with the user information or the user key and manage the virtual assets address in a black address list. The black address list may be delivered to the KYC servers or other address authentication servers.

When the KYC for the user is successful by the KYC server 200 (S150), the virtual assets address authentication server 100 may instruct the terminal 10 to withdraw a predetermined amount of virtual assets (e.g., cryptocurrency, and the like) from the address of the virtual assets to be authenticated (S160). The instruction of the withdrawal of the predetermined amount of virtual assets (e.g., cryptocurrency, and the like) from the address of the virtual assets to be authenticated may be transmitted to the user or the user terminal 10 by various manners. For example, the virtual assets address authentication server 100 may transmit only amount information of the virtual assets to the terminal. Then, the user may withdraw an amount of virtual assets corresponding to the amount information from the virtual assets address.

The virtual assets address authentication server 100 may instruct the terminal 10 to withdraw the asset through a session verified by the KYC server. Here, the predetermined amount of assets may be a specific amount arbitrarily determined by the virtual assets address authentication server 100, and may not be determined until the virtual assets address authentication server 100 arbitrarily determines the amount. That is, the virtual assets address authentication server 100 may randomly determine the amount of assets when instructing the terminal 10 to withdraw the assets.

The virtual assets address authentication server 100 may notify the user of an additional means for verifying the virtual assets address according to the type of the virtual assets. For example, the virtual assets address authentication server 100 may request the user to input specific information (e.g., information agreed in advance between the virtual assets address authentication server 100 and the user) into a metadata field or a tag field of the transaction. In this case, the transaction may correspond to the withdrawal of the indicated amount of assets from the virtual assets address, or to the transfer of the indicated amount of assets to a predetermined address.

Alternatively, the virtual assets address authentication server 100 may instruct the terminal an address to which the indicated amount of assets is to be transferred. For example, the virtual assets address authentication server 100 may instruct the terminal to transfer a specific amount of virtual assets to an address being different from the address where the virtual assets are to be withdrawn. Alternatively, the virtual assets address authentication server 100 may instruct the terminal to transfer a specific amount of virtual assets to another address owned by the user or to another address possessed by the user. Alternatively, the virtual assets address authentication server 100 may instruct the terminal to transfer a specific amount of virtual assets to the same address as the address where the virtual assets will be withdrawn.

Thereafter, the virtual assets address authentication server 100 may monitor that the indicated amount of assets is withdrawn from the virtual assets address (S170). The virtual assets address authentication server 100 may operate a timer while instructing the withdrawal of the predetermined amount of assets, and then, the virtual assets address authentication server 100 may monitor that the indicated amount of assets is withdrawn from the virtual assets address until the timer expires.

The virtual assets address authentication server 100 may monitor a node corresponding to the user terminal 10. Specifically, the virtual assets address authentication server 100 may monitor a block generated by the node corresponding to the terminal 10 and check withdrawal time of the assets from the virtual assets address, the amount of the withdrawn assets, and the like based on the transaction included in the created block. In this case, the time length of the timer may be longer than the time normally required for the block generation.

Thereafter, when it is confirmed that the specific amount of assets are withdrawn from the virtual assets address (S180), the virtual assets address authentication server 100 may authenticate the virtual assets address by confirming that the predetermined amount of assets are withdrawn from the virtual assets address (S190).

It may be confirmed through at least one step of the transaction processes for the virtual assets that the indicated amount of virtual assets is withdrawn from the virtual assets address. For example, when a block containing a transaction corresponding to a withdrawal of an indicated amount of virtual assets from the virtual assets address is propagated to participants in a virtual assets network, the virtual assets address authentication server 100 may confirm that the indicated amount of virtual assets is withdrawn from the virtual assets address of the user. Alternatively, when the block containing the transaction corresponding to the withdrawal of the indicated amount of virtual assets from the virtual assets address is agreed to be legitimate (e.g., an agreement by a majority voting of the participant nodes), the virtual assets address authentication server 100 may confirm that the indicated amount of virtual assets is withdrawn from the virtual assets address of the user. Alternatively, when the block containing the transaction corresponding to the withdrawal of the indicated amount of virtual assets from the virtual assets address is added to a blockchain, the virtual assets address authentication server 100 may confirm that the indicated amount of virtual assets is withdrawn from the virtual assets address of the user.

If the timer related to the withdrawal of the indicated asset is operated, and it is confirmed that the predetermined amount of assets have been withdrawn from the virtual assets address before the timer expires, the virtual assets address authentication server 100 may determine that the virtual assets address is authenticated.

When the virtual assets address is authenticated, the virtual assets address authentication server 100 may match and manage the user information or the user key used for the KYC request with the virtual assets address. Referring to FIG. 4, the KYC history, the corresponding KYC server, the type of the virtual assets, and the virtual assets address is stored with the user ID in the virtual assets address authentication server 100.

On the other hand, if the indicated amount of assets is not withdrawn from the virtual assets address before the timer expires, the virtual assets address authentication server 100 may re-instruct the terminal to withdraw the same amount of assets or may instruct the terminal to withdraw a different amount of assets. Alternatively, when the timer expires without confirmation of the withdrawal of the assets, the virtual assets address authentication server 100 may notify the terminal that the authentication request for the virtual assets address has been rejected, and may manage the rejection history of the authentication request by matching the virtual assets address. For example, the virtual assets address authentication server 100 may match the address rejected for the authentication with the user information or the user key and manage the address as the black address list. The black address list may be shared with the KYC servers or other address authentication servers.

The address authentication apparatus according to an exemplary embodiment can be connected to Exchanges of the virtual assets to provide a decentralized address authentication service for the virtual assets address. The reliability of the address of the virtual assets keeping the virtual assets can be increased through the address authentication method for the virtual assets. In addition, the address authentication method according to an exemplary embodiment can be a solution to the AML problem, and can be used as a means for identification. The virtual assets can be traded internationally, but in the address authentication method according to an exemplary embodiment, the KYC history and related information can be managed by the KYC server installed in each country, so that the problem of taking out personal information abroad can also be solved.

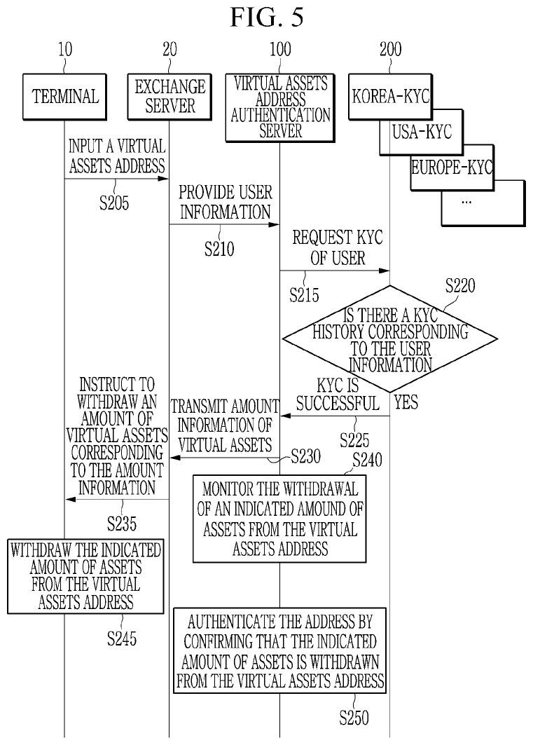

FIG. 5 is a flowchart illustrating a method of providing an address authentication service for authenticating the address of virtual assets according to another exemplary embodiment.

Referring to FIG. 5, a user may request a virtual assets address authentication service through an Exchange server 20. At this time, the user may input his virtual assets address to the Exchange server 20 in order to authenticate the virtual assets address (S205). The user may, through a terminal 10, input the virtual assets address to the Exchange server 20 and transmit and receive various messages with the Exchange server 20.

The Exchange server 20 may transmit the user's request for the virtual assets address authentication service to the virtual assets address authentication server 100 by inputting the user information stored in advance to the virtual assets address authentication server 100 (S210). The user information may include a name, a portable phone number, an address, and/or a date of birth of the user, and may be stored in advance in the Exchange server 20.

The virtual assets address authentication server 100 may request the KYC server to perform a KYC for the user based on the user information of the user (S215). The KYC server may be a server nationally certified, such as a credit bureau (CB). In general, since the CB may receive personal information from financial institutions such as banks and credit card companies in order to evaluate individual credit rating, the server of the CB may be suitable for performing the KYC.

Upon receiving the KYC request for the user, the KYC server 200 may check whether a KYC history corresponding to the user information exists (S220). Each KYC server 200 may perform the KYC according to a predetermined method and level for the individuals and the corporations, and may match and store the user information and the KYC history. The KYC server 200 may update the user information and the KYC history according to a predetermined storage period.

When the KYC for the user is successful by the KYC server 200 (S225), the virtual assets address authentication server 100 may transmit amount information of the virtual assets to the Exchange server 20 (S230). The virtual assets address authentication server 100 may directly indicate additional means for verifying the virtual assets address according to a type of the virtual assets. For example, the virtual assets address authentication server 100 may instruct to input information previously agreed between the virtual assets address authentication server 100 and the user into a metadata field or a tag field of a transaction. In this case, the transaction may correspond to the withdrawal of the indicated amount of assets from the virtual assets address, or to the transfer of the indicated amount of assets to an indicated address.

Alternatively, the virtual assets address authentication server 100 may indicate the address to which the indicated amount of assets is to be transferred. For example, the virtual assets address authentication server 100 may instruct to transfer a specific amount of virtual assets to an address being different from the address where the virtual assets are to be withdrawn. Alternatively, the virtual assets address authentication server 100 may instruct to transfer a specific amount of virtual assets to another address owned by the user or to another address possessed by the user. Alternatively, the virtual assets address authentication server 100 may instruct to transfer a specific amount of virtual assets to the same address as the address where the virtual assets are to be withdrawn.

The Exchange server 20 may instruct the terminal to withdraw the amount of virtual assets corresponding to the amount information from the virtual assets address to be authenticated (S235). The Exchange server 20 may display on the terminal 10 the withdrawal instruction of the amount of virtual assets corresponding to the amount information through an application of the Exchange server 20 in the terminal 10.

Thereafter, the virtual assets address authentication server 100 may monitor that the indicated amount of assets is withdrawn from the virtual assets address (S240). The virtual assets address authentication server 100 may operate a timer while instructing the withdrawal of the predetermined amount of assets, and then, the virtual assets address authentication server 100 may monitor that the indicated amount of assets is withdrawn from the virtual assets address until the timer expires.

The virtual assets address authentication server 100 may monitor a node corresponding to the user terminal 10. Specifically, the virtual assets address authentication server 100 may monitor a block generated by the node corresponding to the terminal 10 and check withdrawal time of the assets from the virtual assets address, the amount of the withdrawn assets, and the like based on the transaction included in the created block. In this case, the time length of the timer may be longer than the time normally required for the block generation.

Thereafter, when it is confirmed that the specific amount of assets are withdrawn from the virtual assets address (S245), the virtual assets address authentication server 100 may authenticate the virtual assets address by confirming that the specific amount of assets are withdrawn from the virtual assets address (S250). When the indicated amount of virtual assets is withdrawn from the virtual assets address, the virtual assets address authentication server 100 may transmit a success message of the address authentication to the Exchange server 20, and the Exchange server 20 may transfer the success message of the address authentication to the terminal 10.

The withdrawal of the specific amount of virtual assets from the virtual assets address may be confirmed through at least one step of the transaction processes for the virtual assets. For example, when a block containing a transaction corresponding to a withdrawal of an indicated amount of virtual assets from the virtual assets address is propagated to participants in a virtual assets network, the virtual assets address authentication server 100 may confirm that the indicated amount of virtual assets is withdrawn from the virtual assets address of the user. Alternatively, when the block containing the transaction corresponding to the withdrawal of the indicated amount of virtual assets from the virtual assets address is agreed to be legitimate (e.g., an agreement by a majority voting of the participant nodes), the virtual assets address authentication server 100 may confirm that the indicated amount of virtual assets is withdrawn from the virtual assets address of the user. Alternatively, when the block containing the transaction corresponding to the withdrawal of the indicated amount of virtual assets from the virtual assets address is added to a blockchain, the virtual assets address authentication server 100 may confirm that the indicated amount of virtual assets is withdrawn from the virtual assets address of the user.

The virtual assets address authentication server 100 may confirm that the specific amount of virtual assets has been transferred from the address to be authenticated to an address to which the virtual assets is to be transferred when the address to which the virtual assets is to be transferred is transmitted to the terminal. For example, the virtual assets address authentication server 100 may confirm that the specific amount of virtual assets has been transferred from the address to be authenticated to an address different from the authentication target address. Alternatively, the virtual assets address authentication server 100 may confirm that the specific amount of virtual assets has been transferred from the address to be authenticated to an address owned or possessed by the user and is different from the address to be authenticated. Alternatively, the virtual assets address authentication server 100 may confirm that the specific amount of virtual assets has been transferred from the authentication targeted address to the same address as the authentication targeted address.

When specific information along with the amount information of the virtual assets is transmitted to the terminal, the virtual assets address authentication server 100 may confirm that the amount of virtual assets corresponding to the amount information is withdrawn from the address to be authenticated and determine that the virtual assets address is authenticated by confirming a withdrawal of the amount of virtual assets corresponding to the amount information from the virtual assets address and by checking whether content corresponding to the specific information is included in a metadata field or a tag field of a transaction corresponding to the withdrawal.

When a timer related to the withdrawal of the indicated asset is executed, and it is confirmed that a predetermined amount of assets have been withdrawn from the virtual assets address before the timer expires, the virtual assets address authentication server 100 may determine that the virtual assets address have been authenticated.

When the virtual assets address is authenticated, the virtual assets address authentication server 100 may match and manage the user information or the user key used for the KYC request with the virtual assets address.

On the other hand, if the indicated amount of assets is not withdrawn from the virtual assets address before the timer expires, the virtual assets address authentication server 100 may instruct the same amount of assets to be withdrawn or may instruct different amount of assets to be withdrawn. Alternatively, when the timer expires without confirmation of the withdrawal of the assets, the virtual assets address authentication server 100 may notify that the authentication request for the virtual assets address has been rejected, and may match the rejection history of the authentication request with the virtual assets address to manage the rejection history. For example, the virtual assets address authentication server 100 may match the rejected address with the user information or the user key and manage the rejected address as a black address list. The black address list may be shared with the KYC servers or other address authentication servers.

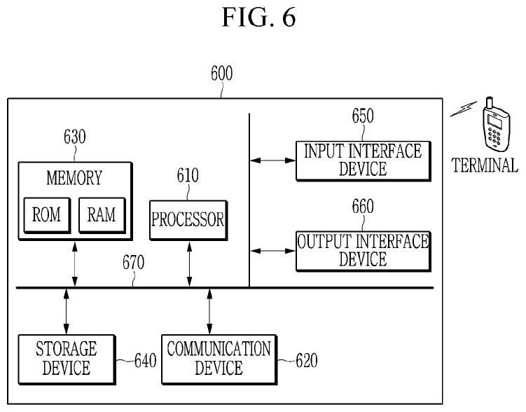

FIG. 6 is a block diagram illustrating an address authentication apparatus and a terminal for virtual assets according to an exemplary embodiment.

The virtual assets address authentication apparatus (or the terminal) according to an exemplary embodiment may be implemented as a computer system, for example, a computer-readable medium. Referring to FIG. 6, the computer system 600 may include at least one of a processor 610, a memory 630, an input interface device 650, an output interface device 660, and a storage device 640 communicating through a bus 670. The computer system 600 may also include a communication device 620 coupled to the network. The processor 610 may be a central processing unit (CPU) or a semiconductor device that executes instructions stored in the memory 630 or the storage device 640. The memory 630 and the storage device 640 may include various forms of volatile or nonvolatile storage media. For example, the memory may include read only memory (ROM) or random access memory (RAM). In the exemplary embodiment of the present disclosure, the memory may be located inside or outside the processor, and the memory may be coupled to the processor through various means already known. The memory is a volatile or nonvolatile storage medium of various types, for example, the memory may include read-only memory (ROM) or random access memory (RAM).

Accordingly, the exemplary embodiment may be implemented as a method implemented in the computer, or as a non-transitory computer-readable medium in which computer executable instructions are stored. In an exemplary embodiment, when executed by a processor, the computer-readable instruction may perform the method according to at least one aspect of the present disclosure.

The communication device 620 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

While this disclosure has been described in connection with what is presently considered to be practical example embodiments, it is to be understood that this disclosure is not limited to the disclosed embodiments.

On the contrary, it is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments.

On the contrary, it is intended to cover various modifications and equivalent arrangements included within the spirit and scope of the appended claims.

What is claimed is:

1. A method for authenticating an address of virtual assets, the method comprising:
requesting a Know Your Customer (KYC) server to perform a KYC of user based on user information of the user;
transmitting amount information of the virtual assets to terminal of the user when the KYC is successful by the KYC server; and
authenticating the address by confirming that an amount of the virtual assets corresponding to the amount information has been withdrawn from the address.

2. The method of claim 1, wherein
the authenticating the address by confirming that an amount of the virtual assets corresponding to the amount information has been withdrawn from the address comprises
confirming that the amount of the virtual assets corresponding to the amount information has been transferred from the address to an address being different from the address.

3. The method of claim 1, wherein
the authenticating the address by confirming that an amount of the virtual assets corresponding to the amount information has been withdrawn from the address comprises
confirming that the amount of the virtual assets corresponding to the amount information has been transferred from the address to an address which is owned or possessed by the user and is different from the address.

4. The method of claim 1, wherein
the authenticating the address by confirming that an amount of the virtual assets corresponding to the amount information has been withdrawn from the address comprises
confirming that the amount of the virtual assets corresponding to the amount information has been transferred from the address to the same address as the address.

5. The method of claim 1, wherein
the transmitting amount information of the virtual assets to terminal of the user comprises
transmitting information about the amount of the virtual assets and a specific address to the terminal, and
the authenticating the address by confirming that an amount of the virtual assets corresponding to the amount information has been withdrawn from the address comprises
confirming that the amount of the virtual assets corresponding to the amount information has been transferred from the address to the specific address.

6. The method of claim 1, wherein
the transmitting amount information of the virtual assets to terminal of the user comprises
transmitting the amount information of the virtual assets and specific information to the terminal, and
the authenticating the address by confirming that an amount of the virtual assets corresponding to the amount information has been withdrawn from the address comprises
confirming that the amount of the virtual assets corresponding to the amount information has been withdrawn from the address;
checking whether contents corresponding to the specific information is included in a metadata field or a tag field of a transaction corresponding to the withdrawal; and
determining that the address is authenticated when it is confirmed that the amount of the virtual assets corresponding to the amount information has been withdrawn from the address and it is confirmed that the contents corresponding to the specific information has been included in the metadata field or the tag field of the transaction corresponding to the withdrawal.

7. The method of claim 1, wherein
the requesting a Know Your Customer (KYC) server to perform a KYC of user based on user information of the user comprises
requesting a KYC server of a country corresponding to nationality information of the user received from the terminal to perform the KYC.

8. The method of claim 1, wherein
the requesting a Know Your Customer (KYC) server to perform a KYC of user based on user information of the user comprises
requesting a KYC server of a country in which an address authentication server is located to perform the KYC, wherein the address authentication performs the method for authenticating of the address of the virtual assets.

9. The method of claim 1, wherein
the requesting a Know Your Customer (KYC) server to perform a KYC of user based on user information of the user comprises
generating a user key based on the user information, and requesting, by using the user key, the KYC server to perform the KYC.

10. The method of claim 1, wherein
the requesting a Know Your Customer (KYC) server to perform a KYC of user based on user information of the user comprises
encrypting the user information and delivering the encrypted user information to the KYC server.

11. The method of claim 1, wherein
after the transmitting amount information of the virtual assets to terminal of the user when the KYC is successful by the KYC server, the method further comprising:
operating a timer and monitoring that an amount of the virtual assets corresponding to the amount information is withdrawn from the address.

12. The method of claim 11, wherein
the authenticating the address by confirming that an amount of the virtual assets corresponding to the amount information has been withdrawn from the address comprises
determining that the address is authenticated when the amount of the virtual assets is withdrawn from the address before the timer expires.

13. The method of claim 11, wherein
the authenticating the address by confirming that an amount of the virtual assets corresponding to the amount information has been withdrawn from the address comprises
confirming that a block containing a transaction corresponding to the withdrawal of the amount of the virtual assets from the address is added to a blockchain.

14. The method of claim 11, wherein
the authenticating the address by confirming that an amount of the virtual assets corresponding to the amount information has been withdrawn from the address comprises
confirming that a block containing a transaction corresponding to the withdrawal of the amount of the virtual assets from the address is agreed to be legitimate.

15. The method of claim 1, further comprising
matching and managing the address and a user key generated based on the user information.

16. The method of claim 1, wherein
the address is a virtual assets address created offline by the user.

17. The method of claim 1, wherein
the address is a virtual assets address created by a virtual assets transaction program.

18. The method of claim 1, wherein
the address is a virtual assets address created by an exchange of the virtual assets.

19. An apparatus for authenticating an address of virtual assets, the apparatus comprising
a processor, a memory, and a communication device, wherein the processor executes a program stored in the memory to perform:
requesting a Know Your Customer (KYC) server to perform a KYC of user through the communication device based on user information of the user;
instructing a terminal of the user through the communication device to withdraw a specific amount of the virtual assets from the address when the KYC is successful by the KYC server; and
determining that the address is authenticated when it is confirmed that the specific amount of the virtual assets are withdrawn from the address.

20. A server for requesting an authentication of an address of virtual assets, the server comprising:
a processor, a memory, and a communication device, wherein the processor executes a program stored in the memory to perform:
receiving, from an address authentication server, an instruction to withdraw a specific amount of the virtual assets from the address of the virtual assets of user when a Know Your Customer (KYC) of the user is successful by a KYC server based on user information of the user;
transferring the instruction to a terminal of the user; and
receiving a success message for the authentication of the address generated by the address authentication server from the address authentication server and transmitting the success message to the terminal when the specific amount of the virtual assets is withdrawn from the address of the virtual assets.
